(19) United States
(12) Patent Application Publication
(10) Pub. No.: US 2025/0214176 A1
(43) Pub. Date: Jul. 3, 2025

(54) MANIFOLD FOR MATERIAL REMOVAL SYSTEM

(71) Applicant: APPLIED MATERIALS, INC., Santa Clara, CA (US)

(72) Inventors: Gagandeep Singh Joshi, Fresno, CA (US); Joseph Frederick Behnke, San Jose, CA (US); Joseph Frederick Sommers, Roseville, CA (US); Glen Mori, Gilroy, CA (US); Hanish Kumar Panavalappil Kumarankutty, Malur (IN); Kirubanandan Shanmugam Naina, Whitefield (IN)

(21) Appl. No.: 18/403,034

(22) Filed: Jan. 3, 2024

(51) Int. Cl. B23K 26/12; B23K 26/04; B23K 26/16; B23K 37/02

(52) U.S. Cl. CPC B23K 26/1224; B23K 26/16; B23K 37/0288; B23K 26/043

(57) ABSTRACT

A system includes a material removal apparatus including a laser. The material removal apparatus is configured to perform a material removal operation with respect to a workpiece. The system further includes a vacuum system configured to provide suction during the material removal operation. The system further includes a manifold configured to remove debris from the workpiece responsive to the suction provided by the vacuum system. The manifold includes a plurality of vanes arranged radially around an open center portion of the manifold. The manifold further includes a shell at least partially enclosing the plurality of vanes.

### TECHNICAL FIELD

Embodiments of the present disclosure generally relate to a manifold for a material removal system, and more specifically to a manifold that is to provide uniform suction to remove debris during a material removal operation.

### BACKGROUND

Material removal systems generate debris when performing a material removal operation. Such debris can often impact the effectiveness and/or precision of the material removal operation. Efficient removal of the generated debris can increase the effectiveness, efficiency, and precision of the material removal operation.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Some embodiments described herein cover a system that includes a material removal apparatus including a laser. The material removal apparatus is configured to perform a material removal operation with respect to a workpiece. The system further includes a vacuum system configured to provide suction during the material removal operation. The system further includes a manifold configured to remove debris from the workpiece responsive to the suction provided by the vacuum system. The manifold includes a plurality of vanes arranged radially around an open center portion of the manifold. The manifold further includes a shell at least partially enclosing the plurality of vanes.

Additional or related embodiments described herein cover a manifold configured to remove debris during a material removal operation performed with respect to a workpiece. The manifold includes a plurality of vanes arranged radially around an open center portion of the manifold. The manifold further includes one or more dividers configured to direct a flow of air from the open center portion to an outlet of the manifold. The manifold further includes a shell at least partially enclosing the plurality of vanes and the one or more dividers.

Further embodiments described herein cover a material removal system. The system includes a vacuum system configured to provide suction during a material removal operation performed with respect to a workpiece. The system further includes a manifold configured to remove debris during the material removal operation. The manifold includes a plurality of vanes arranged radially around an open center portion of the manifold. The manifold further includes one or more dividers configured to direct a flow of air from the open center portion to an outlet of the manifold. The manifold further includes a shell at least partially enclosing the plurality of vanes and the one or more dividers.

Numerous other features are provided in accordance with these and other aspects of the disclosure. Other features and aspects of the present disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts a sectional view of one embodiment of a processing chamber.

FIGS. 2A-2B illustrate simplified side view of systems for performing a material removal operation, according to aspects of the present disclosure.

FIG. 3A illustrates a schematic view of a manifold of a material removal system, according to aspects of the present disclosure.

FIG. 3B illustrates a perspective view of a manifold of a material removal system, according to aspects of the present disclosure.

FIG. 4A illustrates an example heat map showing velocity magnitude in a manifold, according to aspects of the present disclosure.

FIG. 4B illustrates an example plot of velocity magnitude vs. position in a manifold, according to aspects of the present disclosure.

### DETAILED DESCRIPTION OF EMBODIMENTS

Embodiments of the present disclosure are directed to a manifold for a material removal system.

Material removal operations can include mechanical machining operations (e.g., such as turning, milling, drilling, etc.) that use mechanical material removers (e.g., cutting tools, mills, drill bits, etc.) to remove material from a workpiece. Material removal operations can also include laser machining operations, such as laser drilling, laser etching, laser patterning, laser texturing, etc. Such material removal operations often generate debris that is made up of material removed from the workpiece. The generated debris is often collected for disposal.

In material removal operations that use a laser (e.g., such as laser drilling, etc.), the buildup of debris in the target work area on the workpiece can adversely affect the operation. For example, buildup of debris in a laser-drilled hole can scatter the laser beam, making the operation less effective. As more debris builds up, the laser beam becomes less effective, leading to increased drill time to finish laser-drilling the hole. Similarly, where a laser is used to texture the surface of a workpiece, inefficient removal of the generated debris can cause the laser beam to inefficiently perform the surface texturing. The buildup of debris again can scatter the laser beam, causing the laser to inefficiently and/or ineffectively complete the operation.

Conventionally, material removal systems use a vacuum suction system to remove debris generated during a material removal operation. Conventional vacuum suction systems provide suction to the region near where the material removal operation occurs, but do not provide localized suction that is uniform across the surface of the workpiece. Conventional systems provide non-uniform suction which may not effectively remove debris from regions of the workpiece. For example, debris may be removed effectively by a conventional system at a location on the workpiece near the vacuum inlet, but debris may be removed ineffectively at a location that is offset away from the vacuum inlet. This non-uniformity of suction by conventional systems can adversely affect the material removal operations, especially operations using lasers.

Aspects and implementations of the instant disclosure address the above-described and other shortcomings of conventional systems by providing a system having a manifold to provide substantially uniform suction across the surface of a workpiece for the removal of debris generated during a material removal operation. The system described herein may be designed to achieve a debris-free surface during laser material processing (e.g., laser-based material removal). The system may combine a laser material processing setup with an integrated uniform suction mechanism on the material processing platform. Real-time debris removal capability of the system may lead to enhanced production efficiency, improved product quality, and extended equipment lifespan. Particularly, in substrate processing, the system described herein may ensure precise and clean manufacturing processes which result in higher yields, reduced defects and enhanced overall performance of substrate products.

In some embodiments, a system includes a material removal apparatus (e.g., a material processing apparatus, a material processing tool, etc.) including a laser for performing material ablation (e.g., material removal, material processing, etc.). Specifically, the laser may be used for laser drilling, laser texturing, laser etching, and/or laser patterning of a workpiece. In some embodiments, the workpiece is a component of a substrate process chamber. For example, the workpiece may be a faceplate for a process chamber. A vacuum system may be configured to provide suction during the material removal operation, such as during the light matter interaction between the laser and the workpiece. The vacuum system may be for removing debris generated by the material removal operation. The vacuum system may include a debris trap for capturing of the debris so that the debris can be properly disposed.

In some embodiments, the system further includes a manifold fluidly coupled to the vacuum system for removing the generated debris from the workpiece. The manifold may be integrated into the material removal apparatus. In some embodiments, the manifold is disposed proximate the workpiece, such as just above the surface of the workpiece. The manifold may have a substantially ring-shaped profile substantially surrounding the workpiece. The manifold may have an open center portion, through which the laser can be directed to perform the material removal operation with respect to the workpiece. In some embodiments, the manifold includes multiple vanes arranged radially around the open center portion. The vanes may direct a flow of air from within the open center portion into multiple channels formed inside a shell of the manifold. The channels may be formed by dividers inside the shell. By separating the flow of air using the vanes and the dividers within the manifold, the manifold may provide substantially uniform suction across the area of the open center portion. Therefore, the manifold may provide uniform suction across the surface area of the workpiece that is surrounded by the manifold. Additionally, the manifold described herein is scalable, meaning the manifold can be manufactured to different size specifications depending on application-specific parameters, such as size constraints, flow constraints, etc.

Embodiments of the present disclosure provide advantages over conventional systems described above. Particularly, some embodiments described herein provide uniform suction for real-time removal of debris generated during a material removal operation. The uniform suction may quickly remove debris as the material removal operation is performed in real-time, reducing the ill affects of debris interfering with the operation, especially when a laser is used to perform laser drilling or texturing. Moreover, quickly removing the generated debris allows for faster laser material removal operations, reducing the amount of time that is needed to complete the operation. The real-time removal of generated debris may also ensure uninterrupted production processes. Therefore, total system throughput can be increased when using a manifold described herein to remove debris. Further, the real-time removal of debris during material processing minimizes surface imperfections on the workpiece and may ensure a stable material processing environment which may minimize process variations, leading to superior product quality and consistency when compared to conventional solutions. Additionally, by maintaining a debris-free surface, energy usage can be optimized for performing a laser-based material removal operation and the amount of material waste reduced.

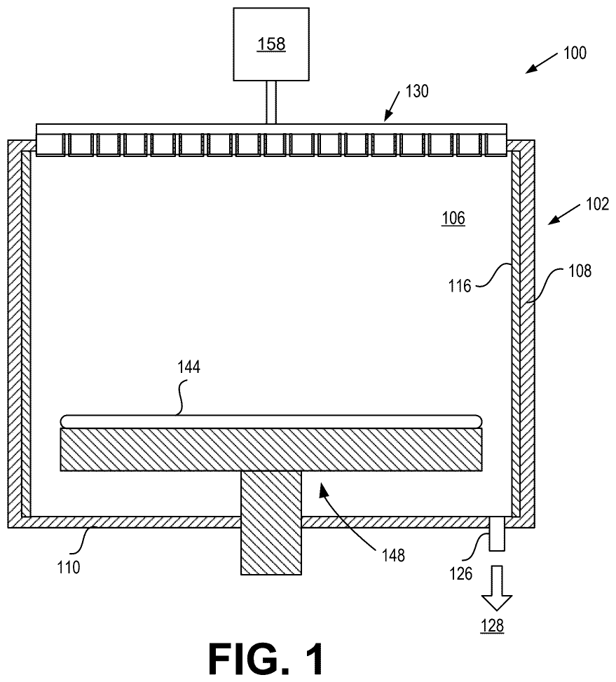

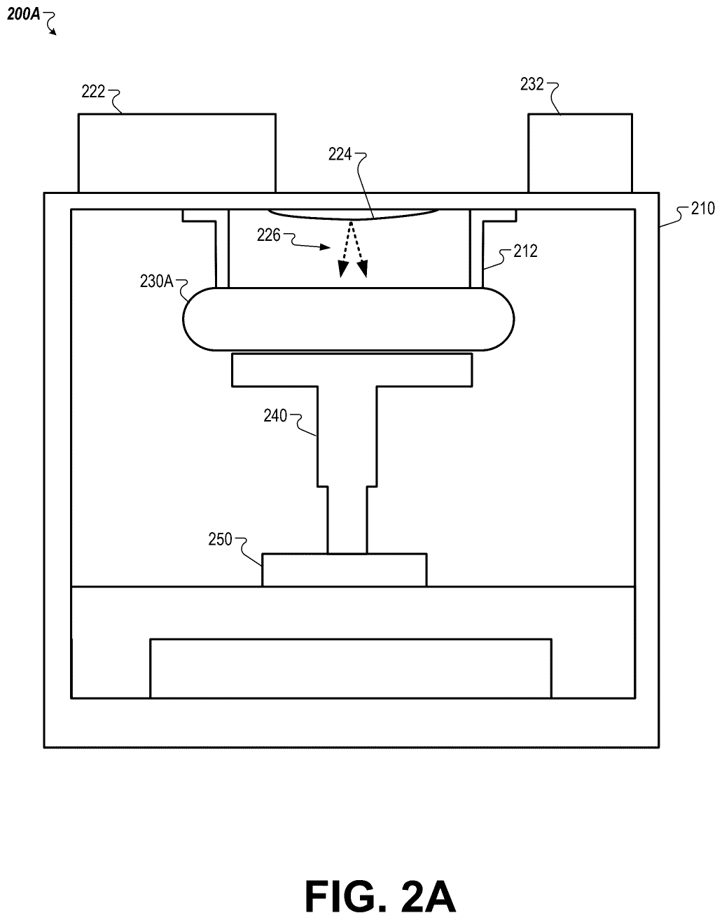

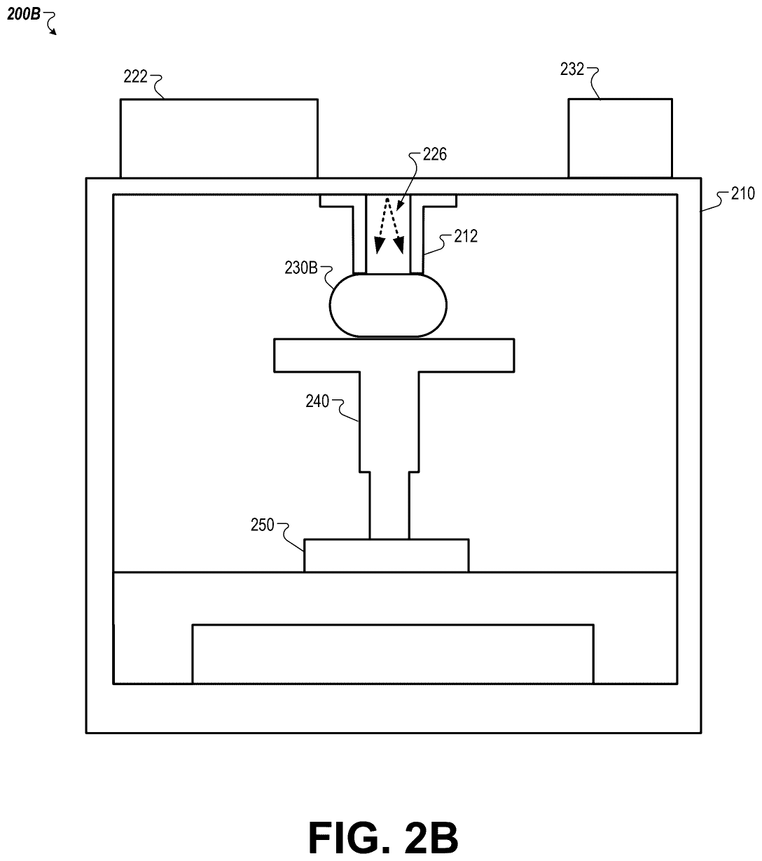

FIG. 1 is a sectional view of a processing chamber 100 (e.g., a semiconductor processing chamber, display processing chamber, etc.) having one or more chamber components that have been manufactured using system 200A of FIG. 2A or system 200B of FIG. 2B, in accordance with embodiments of the present disclosure. The processing chamber 100 may be used, for example, for processes in which a corrosive plasma environment having plasma processing conditions is provided. For example, the processing chamber 100 may be a chamber for a plasma etcher or plasma etch reactor, a plasma cleaner, and so forth. Other types of chambers may include deposition chambers, clean chambers, oxidation chambers, and so on. Examples of chamber components that may be manufactured using a laser-based material removal operation include a substrate support assembly 148, an electrostatic chuck (ESC), a ring (e.g., a process kit ring or single ring), a chamber wall, a base, a gas distribution plate, a showerhead 130, gas lines, a nozzle, a lid, a liner, a liner kit, a shield, a plasma screen, a flow equalizer, a cooling base, a chamber viewport, a chamber lid, and so on. The chamber components may be composed of metals, metal alloys, ceramics, and any combination thereof. The chamber components may include coatings, such as plasma resistant or corrosion resistant coatings. The coatings may be coatings deposited or grown via atomic layer deposition, plasma spray coating, chemical vapor deposition, ion-assisted deposition, sputtering, physical vapor deposition, electroplating, anodization, and so on.

In one embodiment, the processing chamber 100 includes a chamber body 102 and a showerhead 130 that enclose an interior volume 106. The showerhead 130 may include a showerhead base and a showerhead gas distribution plate. Alternatively, the showerhead 130 may be replaced by a lid and a nozzle in some embodiments. The chamber body 102 may be fabricated from aluminum, stainless steel or other suitable material. The chamber body 102 generally includes sidewalls 108 and a bottom 110. Any of the showerhead 130 (or lid and/or nozzle), sidewalls 108 and/or bottom 110 may include a coating.

An outer liner 116 may be disposed adjacent the sidewalls 108 to protect the chamber body 102. In one embodiment, the outer liner 116 is fabricated from aluminum oxide.

An exhaust port 126 may be defined in the chamber body 102, and may couple the interior volume 106 to a pump system 128. The pump system 128 may include one or more pumps and throttle valves utilized to evacuate and regulate the pressure of the interior volume 106 of the processing chamber 100.

The showerhead 130 may be supported on the sidewall 108 and/or top of the chamber body 102. The showerhead 130 (or lid) may be opened to allow access to the interior volume 106 of the processing chamber 100 in some embodiments, and may provide a seal for the processing chamber 100 while closed. A gas panel 158 may be coupled to the processing chamber 100 to provide process and/or cleaning gases to the interior volume 106 through the showerhead 130 or lid and nozzle. Showerhead 130 is used for processing chambers used for dielectric etch (etching of dielectric materials). The showerhead 130 may include a gas distribution plate (GDP) having multiple gas delivery holes 132 throughout the GDP. The showerhead 130 may include the GDP bonded to an aluminum showerhead base or an anodized aluminum showerhead base. The GDP 133 may be made from Si or SiC, or may be a ceramic such as Y₂O₃, Al₂O₃, YAG, and so forth. Showerhead 130 and delivery holes 132 may be manufactured using a laser-based material removal operation in some embodiments. For processing chambers used for conductor etch (etching of conductive materials), a lid may be used rather than a showerhead. The lid may include a center nozzle that fits into a center hole of the lid. The lid may be a ceramic such as Al₂O₃, Y₂O₃, YAG, or a ceramic compound comprising Y₄Al₂O₉ and a solid-solution of Y₂O₃—ZrO₂. The nozzle may also be a ceramic, such as Y₂O₃, YAG, or the ceramic compound comprising Y₄Al₂O₉ and a solid-solution of Y₂O₃—ZrO₂.

The substrate support assembly 148 is disposed in the interior volume 106 of the processing chamber 100 below the showerhead 130 or lid. The substrate support assembly 148 holds the substrate 144 during processing and may include an electrostatic chuck bonded to a cooling plate.

An inner liner may be on the periphery of the substrate support assembly 148. The inner liner may be a halogen-containing gas resist material such as those discussed with reference to the outer liner 116. In one embodiment, the inner liner 118 may be fabricated from the same materials of the outer liner 116.

FIG. 2A illustrates a simplified side view of a system 200A for performing a material removal operation, according to aspects of the present disclosure. In some embodiments, system 200A includes an exhaust manifold 230A for collecting and removing debris generated during a material removal operation (e.g., a laser-based material removal operation such as laser drilling, laser texturing, laser etching, laser patterning, etc.).

In some embodiments, a frame 210 at least partially encloses at least some of the components of system 200A. The manifold 230A, a pedestal 240, and/or a stage 250 may be at least partially enclosed and/or disposed within frame 210. In some embodiments, a lens 224 is supported at or near the top of frame 210. The lens may be an F-Theta lens. A laser unit 222 may generate a laser beam 226 which is conveyed to the lens 224 and emitted towards a top surface of a workpiece supported on top of the pedestal 240. The laser unit 222 may be a power source for the laser beam 226. The laser beam may be conveyed from the laser unit 222 to the lens 224 via an optical conduit, such as an optical fiber. The lens 224 may direct the laser beam 226 towards the workpiece through an open center portion of the manifold 230A. In some embodiments, the lens 224 includes a galvo to direct the laser beam 226 back-and-forth across the surface of the workpiece. In some embodiments, the lens 224 focusses the laser beam 226 onto the surface of the workpiece. The laser beam 226 may be used to remove material from the workpiece, such as for performance of a laser-based material removal operation with respect to the workpiece. One example of a laser-based material removal operation may include a laser drilling operation which may include drilling, using a laser, one or more holes in the surface of the workpiece. Another example of a laser-based material removal operation may include a laser texturing operation which may include texturing, using a laser, a pattern on the surface of the workpiece. Other laser-based material removal operations such as laser etching or laser patterning, etc. are possible.

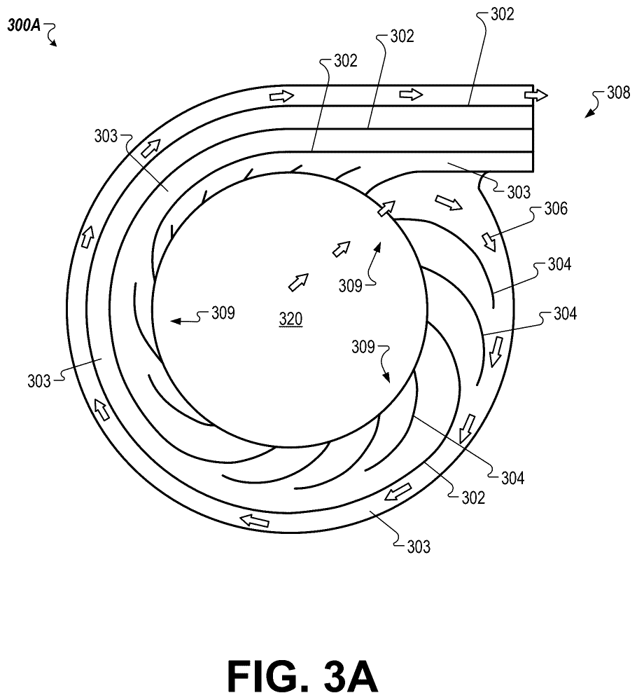

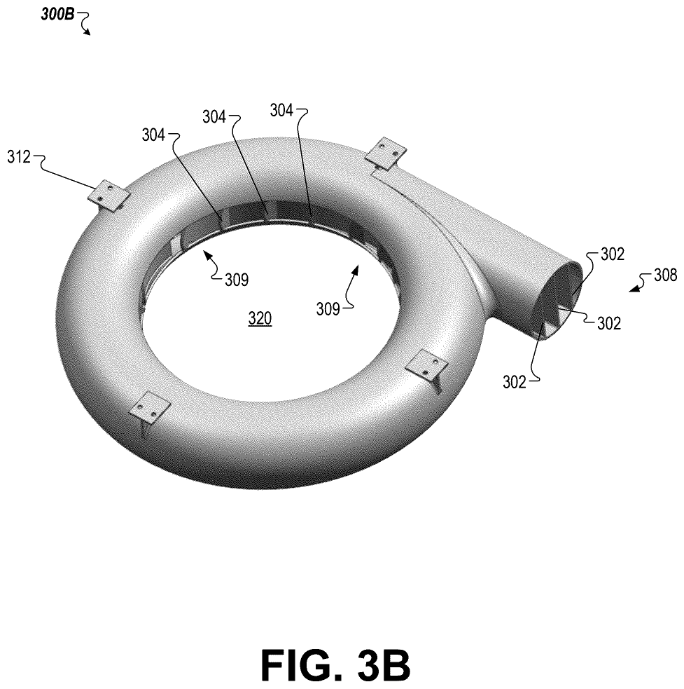

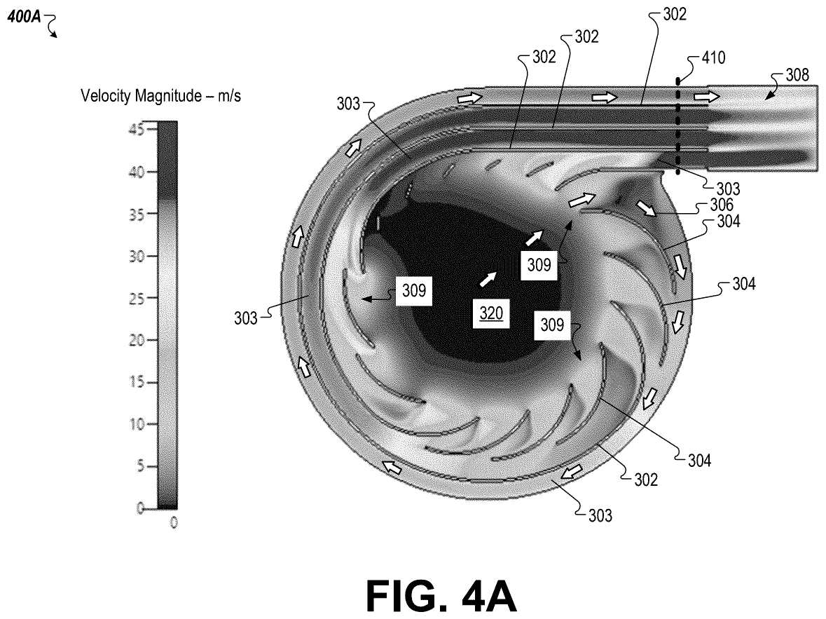

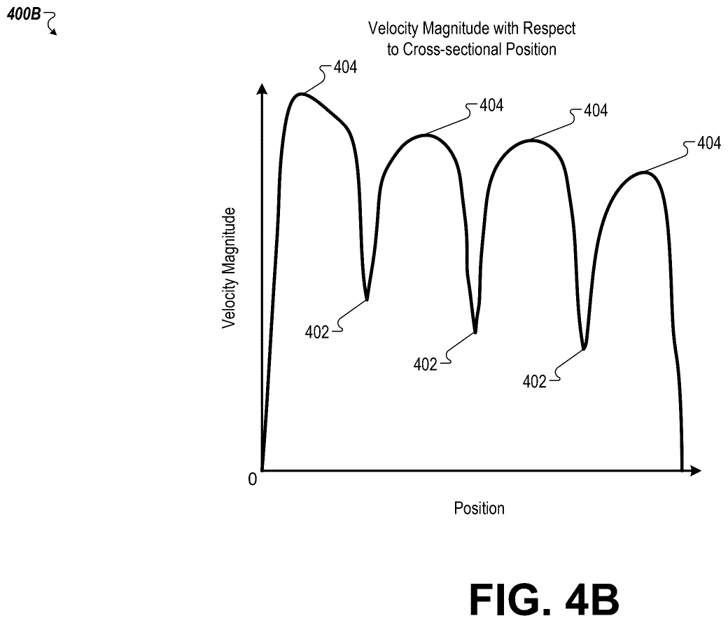

Manifold 230A may be supported by one or more brackets 212. In some embodiments, two or more brackets 212 support manifold 230A from the top of frame 210. Manifold 230A may be supported by four brackets 212. In some embodiments, the brackets 212 couple to the outer shell of the manifold 230A. The manifold 230A may include multiple vanes that are arranged radially around an open center portion. The vanes may be disposed within the outer shell. Further, the manifold 230A may include multiple dividers to direct air from the open center portion to a manifold outlet. In some embodiments, the arrangement of vanes and/or dividers provides uniform suction across the open center portion when vacuum is applied to the outlet of the manifold 230A. More details associated with the arrangement of vanes and/or dividers of the manifold 230A are described herein below with respect to FIGS. 3A-4B.

In some embodiments, manifold 230A surrounds a workpiece supported on pedestal 240. The workpiece may be supported within the center of the open center portion of the manifold 230A. The lens 224 may direct the laser beam 226 through the open center portion towards the workpiece for performing a material removal operation. During the material removal operation performed with respect to the workpiece, the manifold 230A may facilitate removal of generated debris. In some embodiments, a vacuum system 232 is fluidly coupled to the manifold 230A by a conduit such as a vacuum hose, etc. The vacuum system 232 may include a vacuum source (e.g., such as a vacuum pump, etc.) and a filter. During the material removal operation, the vacuum system 232 may provide suction (e.g., via the vacuum source) to “suck” the generated debris away from the workpiece via the manifold 230A. The manifold may be configured to remove the generated debris responsive to the suction provided by the vacuum system 232. The filter of the vacuum system 232 may catch the removed debris and/or may store the debris for proper disposal. The filter may be removed for cleaning or disposal when the filter becomes full of debris.

In some embodiments, the workpiece is a component of a substrate processing chamber. For example, the workpiece may be a faceplate, a showerhead, a lid, or another chamber component, etc. In some embodiments, the stage 250 is a movable stage to move the pedestal 240 (e.g., and the supported workpiece) so that the material removal operation can be performed with respect to multiple regions of the workpiece surface. For example, the stage 250 may move the pedestal 240 and the workpiece so that a patterning or texturing operation can be performed across the surface of the workpiece, using laser beam 226 to remove material from multiple regions of the surface of the workpiece.

In some embodiments, the size of the open center portion of the manifold 230A corresponds with the size of the top surface of the pedestal 240. For example, the open center portion of the manifold 230A may have substantially the same size as the top surface of the pedestal 240. In some embodiments, the open center portion of the manifold 230A has substantially the same size as the workpiece. In some embodiments, the open center portion has a diameter of between approximately 12 inches and approximately 18 inches. In some embodiments, the open center portion has a nominal diameter of approximately 14 inches. The diameter of the open center portion may correspond to the diameter of the workpiece surface. The diameter of the workpiece may be smaller than the diameter of the open center portion so that the workpiece can fit within the open center portion. Other sizes of the manifold 230A are possible. For example, the open center portion of the manifold 230A may be larger or smaller to accommodate different-sized workpieces, such as described herein below with respect to FIG. 2B.

FIG. 2B illustrates a simplified side view of a system 200B for performing a material removal operation, according to aspects of the present disclosure. In some embodiments, system 200B includes an exhaust manifold 230B for collecting and removing debris generated during a material removal operation. Manifold 230B may have substantially the same characteristics and/or features as manifold 230A except as described herein below.

In some embodiments, manifold 230B has a diameter substantially smaller than the diameter of the top surface of pedestal 240 and/or a workpiece supported by pedestal 240. In some embodiments, the open center portion of manifold 230B has a smaller diameter than the open center portion of manifold 230A. For example, the diameter of the open center portion of manifold 230B may be between approximately 6 inches and approximately 10 inches. In some embodiments, the diameter of the open center portion of manifold 230B corresponds to the diameter of the field of view of laser beam 226. For example, the diameter of the open center portion of manifold 230B may be only slightly larger than the field of view of laser beam 226 so that the manifold 230B does not interfere with the laser beam 226.

The smaller relative size of the manifold 230B compared to manifold 230A provides localized suction. For example, uniform suction provided via manifold 230B is localized to a smaller area of the workpiece when compared to the uniform suction provided via manifold 230A. The workpiece may be moved (e.g., by the stage 250) so that localized suction is provided where a material removal operation is performed with respect to the workpiece. By providing localized suction, debris removal may be even more efficient than conventionally-used techniques. In some embodiments, the smaller size of manifold 230B (e.g., relative to manifold 230A) is to accommodate smaller workpieces, such as workpieces having a smaller diameter, etc. The sizes of the manifolds 230A and/or manifold 230B are scalable, meaning the manifolds can be constructed to have different sizes to fit a variety of applications.

FIG. 3A illustrates a schematic view 300A of a manifold of a material removal system, according to aspects of the present disclosure. FIG. 3B illustrates a perspective view 300B of a manifold of a material removal system, according to aspects of the present disclosure. The views 300A and 300B may correspond to manifold 230A of FIG. 2A or manifold 230B of FIG. 2B.

Referring to FIG. 3A, in some embodiments, the manifold includes multiple vanes 304 and multiple dividers 302 to channel moving air 306 from multiple suction inlets 309 to a suction outlet 308. The multiple vanes 304 may be arranged radially around the open center portion 320 of the manifold. The vanes 304 may be equally spaced from one another around the open center portion 320. The manifold may be configured to fluidly couple to a vacuum system that can supply vacuum to the manifold via the suction outlet 308. During a material removal operation, a workpiece may be disposed within the open center portion 320. When suction is applied to the suction outlet 308 (e.g., by a vacuum system having a vacuum source), air 306 may be drawn in through the suction inlets 309 between the vanes 304. In some embodiments, the manifold is configured to flow air between approximately 180 cubic feet per minute (CFM) and approximately 500 CFM.

In some embodiments, the vanes 304 define inlet flow channels through which the drawn in air 306 may flow. Subsets of the inlet flow channels may be combined to form intermediate flow channels 303. The intermediate flow channels 303 may be separated by dividers 302. In some examples, two or more vanes 304 define adjacent inlet flow channels. The adjacent inlet flow channels may be combined at a region where the vanes 304 end (e.g., where the vanes 304 no longer divide the flow of air 306 into separate adjacent inlet flow channels). Subset of the adjacent inlet flow channels may be combined into intermediate flow channels 303. In some embodiments, the manifold includes four different intermediate flow channels 303 separated by three dividers 302. In some embodiments, at least one of the intermediate flow channels 303 is circumferentially arranged around the open center portion 320.

In some embodiments, the arrangement of vanes 304 and dividers 302 provides substantially uniform suction within the open center portion 320 when vacuum is applied to the suction outlet 308. The substantially uniform suction within the open center portion 320 enables debris to be efficiently removed by the manifold (e.g., such as during a laser-based material removal process as described herein above) regardless of where within the open center portion 320 the debris is located.

In some embodiments, to generate the uniform suction, the vanes 304 are positioned so that air 306 flows equally through each of the suction inlets 309 into each of the inlet flow channels defined by the vanes 304. A subset of the vanes 304 may guide a portion of the flow of air 306 from the open center portion 320 into an intermediate flow channel 303. Similarly, in some embodiments, the inlet flow channels are combined into intermediate flow channels 303 so that each of the intermediate flow channels 303 flow substantially the same amount of air 306. For example, a first intermediate flow channel 303 receives air 306 from three different inlet flow channels, a second intermediate flow channel 303 receives air 306 from four different inlet flow channels, a third intermediate flow channel 303 receives air 306 from three different inlet flow channels, and a fourth intermediate flow channel 303 receives air 306 from six different inlet flow channels.

In some embodiments, vacuum can be selectively applied to the different intermediate flow channels 303 at the suction outlet 308. Selectively applying vacuum to the different intermediate flow channels 303 may alter the flow of air in the open center portion 320 of the manifold. For example, to target removal of debris from a target region within the open center portion 320, vacuum can be applied to an intermediate flow channel 303 that corresponds to the target region. Similarly, vacuum levels can be altered to the different intermediate flow channels 303 to provide non-uniform suction in the open center portion 320.

Referring to FIG. 3B, a perspective view 300B of a manifold is shown. In some embodiments, the manifold includes an outer shell that substantially surrounds the vanes 304 and the dividers 302. The shell may at least partially define an open center portion 320, within which a workpiece can be disposed during a material removal operation. The outer shell may at least partially form the flow channels formed by the vanes 304 and/or the dividers 302. In some embodiments, the manifold shell forms a substantially ring-shaped profile. The ring-shaped profile surrounds the open center portion 320. The manifold shell may have a substantially round cross-section. The round cross-section of the shell may be interrupted by the suction inlets 309 where air 306 can enter the shell between vanes 304. In some embodiments, the suction outlet 308 has a round cross-section. Dividers 302 may divide the suction outlet 308 into separate flow channels (e.g., intermediate flow channels 303). The shell may include brackets 312 for coupling the manifold to a support structure.

Due to the complex geometries of the manifold described herein (e.g., multiple interior vanes 304, multiple interior dividers 302, substantially round cross-section, etc.), a manifold as described herein may be manufactured by additive manufacturing (e.g., such as 3D printing, etc.). In some embodiments, the manifold may be constructed of plastic (e.g., such as one or more polymers). In other embodiments, the manifold may be constructed of a metal alloy.

FIG. 4A illustrates an example heat map 400A showing velocity magnitude in a manifold, according to aspects of the present disclosure. The velocity magnitudes shown in heat map 400A may correspond to when a vacuum is applied to the manifold outlet 308. In some embodiments, the velocity of air 306 is substantially uniform across the open center portion 320. The velocity magnitude may be substantially uniform in all directions within the open center portion 320. As the air 306 enters the suction inlets 309 between the vanes 304, the velocity magnitude may increase. Similarly, the velocity magnitude may increase as the air flows through/around the intermediate flow channels 303 toward the suction outlet 308.

FIG. 4B illustrates an example plot 400B of velocity magnitude vs. position in a manifold, according to aspects of the present disclosure. The plot 400B may show the velocity magnitude of air 306 at cross-section 410 in FIG. 4A. In some embodiments, the velocity magnitude has multiple local maximums 404 and multiple local minimums 402. In some embodiments, the local maximums 404 correspond to positions in the centers of intermediate flow channels 303 and the local minimums 402 correspond to positions at the edges of the intermediate flow channels 303. The local minimums 402 may be at positions adjacent to the dividers 302 within the cross-section of the manifold.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within +10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system, comprising:
a material removal apparatus comprising a laser, wherein the material removal apparatus is configured to perform a material removal operation with respect to a workpiece;
a vacuum system configured to provide suction during the material removal operation; and
a manifold configured to remove debris from the workpiece responsive to the suction provided by the vacuum system, wherein the manifold comprises:
a plurality of vanes arranged radially around an open center portion of the manifold; and
a shell at least partially enclosing the plurality of vanes.

2. The system of claim 1, wherein the manifold further comprises:
one or more dividers configured to direct a flow of air from the open center portion to an outlet of the manifold, wherein the vacuum system is coupled to the outlet of the manifold.

3. The system of claim 2, wherein one of the one or more dividers form one or more channels within the shell, and wherein a subset of the plurality of vanes guide a portion of the flow of air from the open center portion into a first channel of the one or more channels.

4. The system of claim 1, wherein the manifold is configured to provide substantially uniform suction across an area of the open center portion of the manifold.

5. The system of claim 1, wherein the workpiece comprises a component of a substrate processing chamber.

6. The system of claim 1, wherein the vacuum system comprises a filter to catch the removed debris.

7. The system of claim 1, wherein the manifold further comprises a substantially ring-shaped profile and a substantially round cross-section.

8. The system of claim 1, wherein the material removal apparatus is configured to direct the laser through the open center portion of the manifold towards a top surface of the workpiece to perform the material removal operation.

9. The system of claim 8, wherein the shell is configured to substantially surround the workpiece within the open center portion.

10. The system of claim 1, further comprising:
a movable stage configured to support the workpiece, wherein the movable stage is movable relative to the laser and the manifold.

11. A manifold configured to remove debris during a material removal operation performed with respect to a workpiece, the manifold comprising:
a plurality of vanes arranged radially around an open center portion of the manifold;
one or more dividers configured to direct a flow of air from the open center portion to an outlet of the manifold; and
a shell at least partially enclosing the plurality of vanes and the one or more dividers.

12. The manifold of claim 11, wherein the one or more dividers form one or more channels within the shell, and wherein a subset of the plurality of vanes guide a portion of the flow of air from the open center portion into a first channel of the one or more channels.

13. The manifold of claim 11, wherein the manifold is configured to provide substantially uniform suction across an area of the open center portion of the manifold.

14. The manifold of claim 11, wherein the manifold further comprises a substantially ring-shaped profile and a substantially round cross-section.

15. The manifold of claim 11, wherein the manifold is configured to fluidly couple to a vacuum system configured to provide suction during a material removal operation.

16. A material removal system, comprising:
a vacuum system configured to provide suction during a material removal operation performed with respect to a workpiece; and
a manifold configured to remove debris during the material removal operation, wherein the manifold comprises:
a plurality of vanes arranged radially around an open center portion of the manifold;
one or more dividers configured to direct a flow of air from the open center portion to an outlet of the manifold; and
a shell at least partially enclosing the plurality of vanes and the one or more dividers.

17. The material removal system of claim 16, wherein the one or more dividers form one or more channels within the shell, and wherein a subset of the plurality of vanes guide a portion of the flow of air from the open center portion into a first channel of the one or more channels.

18. The material removal system of claim 16, wherein the manifold is configured to provide substantially uniform suction across an area of the open center portion of the manifold.

19. The material removal system of claim 16, wherein the workpiece comprises a component of a substrate processing chamber.

20. The material removal system of claim 16, wherein the shell is configured to substantially surround the workpiece within the open center portion.

1. A system, comprising:
a material removal apparatus comprising a laser, wherein the material removal apparatus is configured to perform a material removal operation with respect to a workpiece;
a vacuum system configured to provide suction during the material removal operation; and
a manifold configured to remove debris from the workpiece responsive to the suction provided by the vacuum system, wherein the manifold comprises:
a plurality of vanes arranged radially around an open center portion of the manifold; and
a shell at least partially enclosing the plurality of vanes.

2. The system of claim 1, wherein the manifold further comprises:
one or more dividers configured to direct a flow of air from the open center portion to an outlet of the manifold, wherein the vacuum system is coupled to the outlet of the manifold.

3. The system of claim 2, wherein one of the one or more dividers form one or more channels within the shell, and wherein a subset of the plurality of vanes guide a portion of the flow of air from the open center portion into a first channel of the one or more channels.

4. The system of claim 1, wherein the manifold is configured to provide substantially uniform suction across an area of the open center portion of the manifold.

5. The system of claim 1, wherein the workpiece comprises a component of a substrate processing chamber.

6. The system of claim 1, wherein the vacuum system comprises a filter to catch the removed debris.

7. The system of claim 1, wherein the manifold further comprises a substantially ring-shaped profile and a substantially round cross-section.

8. The system of claim 1, wherein the material removal apparatus is configured to direct the laser through the open center portion of the manifold towards a top surface of the workpiece to perform the material removal operation.

9. The system of claim 8, wherein the shell is configured to substantially surround the workpiece within the open center portion.

10. The system of claim 1, further comprising:
a movable stage configured to support the workpiece, wherein the movable stage is movable relative to the laser and the manifold.

11. A manifold configured to remove debris during a material removal operation performed with respect to a workpiece, the manifold comprising:
a plurality of vanes arranged radially around an open center portion of the manifold;
one or more dividers configured to direct a flow of air from the open center portion to an outlet of the manifold; and
a shell at least partially enclosing the plurality of vanes and the one or more dividers.

12. The manifold of claim 11, wherein the one or more dividers form one or more channels within the shell, and wherein a subset of the plurality of vanes guide a portion of the flow of air from the open center portion into a first channel of the one or more channels.

13. The manifold of claim 11, wherein the manifold is configured to provide substantially uniform suction across an area of the open center portion of the manifold.

14. The manifold of claim 11, wherein the manifold further comprises a substantially ring-shaped profile and a substantially round cross-section.

15. The manifold of claim 11, wherein the manifold is configured to fluidly couple to a vacuum system configured to provide suction during a material removal operation.

16. A material removal system, comprising:
a vacuum system configured to provide suction during a material removal operation performed with respect to a workpiece; and
a manifold configured to remove debris during the material removal operation, wherein the manifold comprises:
a plurality of vanes arranged radially around an open center portion of the manifold;
one or more dividers configured to direct a flow of air from the open center portion to an outlet of the manifold; and
a shell at least partially enclosing the plurality of vanes and the one or more dividers.

17. The material removal system of claim 16, wherein the one or more dividers form one or more channels within the shell, and wherein a subset of the plurality of vanes guide a portion of the flow of air from the open center portion into a first channel of the one or more channels.

18. The material removal system of claim 16, wherein the manifold is configured to provide substantially uniform suction across an area of the open center portion of the manifold.

19. The material removal system of claim 16, wherein the workpiece comprises a component of a substrate processing chamber.

20. The material removal system of claim 16, wherein the shell is configured to substantially surround the workpiece within the open center portion.
